(19) United States
(12) Patent Application Publication
(10) Pub. No.: US 2021/0256347 A1
(43) Pub. Date: Aug. 19, 2021

(54) LOW COMPLEXITY FIBER NONLINEARITY COMPENSATION USING LOOKUP TABLE

(71) Applicant: NEC Laboratories America, Inc., Princeton, NJ (US)

(72) Inventors: Shinsuke FUJISAWA, Princeton, NJ (US); Fatih YAMAN, Princeton, NJ (US); Eduardo Mateo RODRIGUEZ, Tokyo (JP); Yoshihisa INADA, Tokyo (JP); Kohei NAKAMURA, Tokyo (JP); Takanori INOUE, Tokyo (JP)

(73) Assignee: NEC LABORATORIES AMERICA, INC, Princeton, NJ (US)

(21) Appl. No.: 17/147,380

(22) Filed: Jan. 12, 2021

Related U.S. Application Data
(60) Provisional application No. 62/960,252, filed on Jan. 13, 2020.

(51) Int. Cl. G06N 3/04; H04B 10/2543

(52) U.S. Cl. CPC G06N 3/04; H04B 10/2543

(57) ABSTRACT

Aspects of the present disclosure describe optical transmission systems exhibiting low complexity fiber nonlinearity compensation provided by neural networks using lookup tables for multiplication operations.

### CROSS REFERENCE

This disclosure claims the benefit of U.S. Provisional Patent Application Ser. No. 62/960,252 filed Jan. 13, 2020 the entire contents of which is incorporated by reference as if set forth at length herein.

### TECHNICAL FIELD

This disclosure relates generally to optical fiber transmission. More particularly it describes optical fiber nonlinearity compensation using a lookup table.

### BACKGROUND

Nonlinearity is a known problem in optical fiber transmission systems resulting in signal degradation and reduced data transmission capacity. Such reduced data transmission resulting from nonlinearity in undersea optical fiber/cable systems is particularly problematic.

### SUMMARY

The above problems are solved and an advance in the art is made according to aspects of the present disclosure directed to optical fiber nonlinearity compensation. In sharp contrast to the prior art, systems, methods and structures providing optical fiber nonlinearity compensation according to aspects of the present disclosure employ neural-network nonlinearity compensation (NN-NLC) wherein complexity is reduced, and performance is improved, by replacing multiplication operations with a lookup table. Advantageously, complexity of the NN-NLC is reduced significantly—as compared to the prior art.

### BRIEF DESCRIPTION OF THE DRAWING

A more complete understanding of the present disclosure may be realized by reference to the accompanying drawing in which:

FIG. 1 is a schematic diagram showing an illustrative architecture for a deep neural network (DNN) based nonlinear compensation (NN-NLC) according to aspects of the present disclosure;

FIG. 2 is a schematic diagram showing illustrative two lookup tables (LUTs) for implementing NN-NLC according to aspects of the present disclosure;

FIG. 3 shows a constellation plot illustrating possible values of corresponding triplets from 16 QAM according to aspects of the present disclosure;

FIG. 4 shows a plot illustrating Q-improvement dependency on bit resolution according to aspects of the present disclosure; and

FIG. 5 shows a schematic diagram illustrating LUT-based NN-NLC according to aspects of the present disclosure.

The illustrative embodiments are described more fully by the Figures and detailed description. Embodiments according to this disclosure may, however, be embodied in various forms and are not limited to specific or illustrative embodiments described in the drawing and detailed description.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we begin by noting that nonlinearity of optical fiber transmission lines is a significant infirmity that results in signal degradation and reduced data-carrying capacity. Such infirmity is of particular concern in submarine systems—where optical fiber is deployed in undersea environments.

In an attempt to solve these problems, the prior art has proposed approaches that include neural networks (NN) to compensate for nonlinearity without prior knowledge of link/signal parameters. In furtherance of such approaches, experiments have demonstrated that NN-based nonlinearity compensation show better performance—as compared with digital signal processor (DSP)-based approaches.

In particular, the complexity of NN-NLC has been reduced by moving the NN-NLC to a transmitter side of a transmission system after trimming unimportant input nodes. Still, the complex multiplication is performed at each node and complexity remains proportional to the number of input nodes. As a result, the number of input nodes is quite small given a limited computation resource. As such, any performance improvement resulting from using NN-NLC becomes less significant due to computation resource limitations and complexities of the neural networks remain a significant impediment to their adoption and use for NLC.

As noted previously and in sharp contrast to the prior art, the present disclosure describes an improved NN-based nonlinearity compensation for optical fiber transmission in which complex multiplication performed in the NN ASIC is replaced by lookup table resulting in significant performance improvements over the art.

More specifically, the lookup table employed in the NN according to aspects of the present disclosure provides that the multiplication and addition are replaced by two lookup tables (LUTs) in all of the nodes. As a result, computation complexity is reduced from O(n) to O(1)

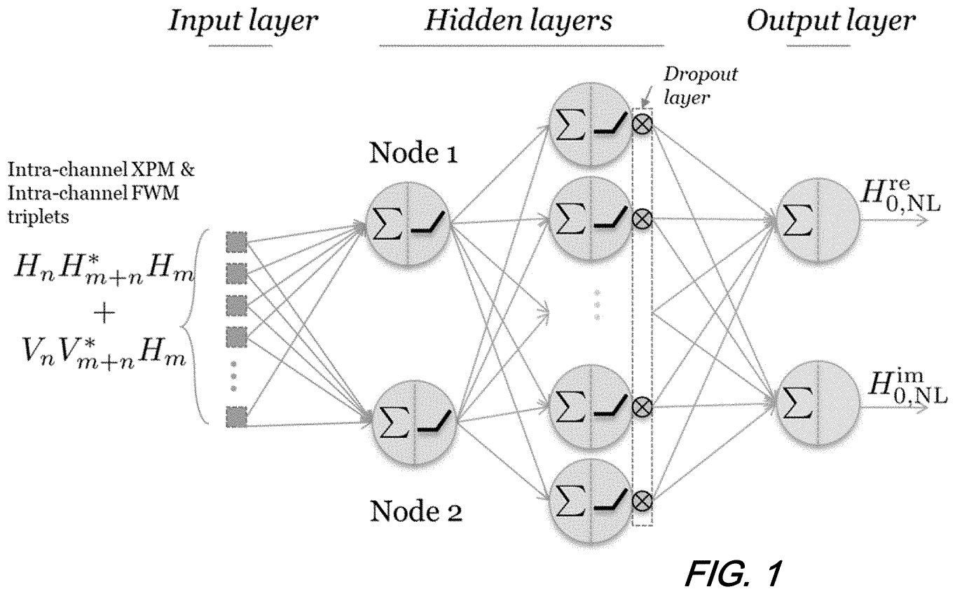

FIG. 1 is a schematic diagram showing an illustrative architecture for a deep neural network (DNN) based nonlinear compensation (NN-NLC) according to aspects of the present disclosure. As we shall show and describe, instead of directly feeding recovered symbols H in x-polarization and V in y-polarization into NN as disclosed in the art, with systems, methods, and structures according to aspects of the present disclosure, intrachannel XPM and intrachannel FWM triplets are computed from the recovered symbols spanning a symbol window length L around the symbol of interested H₀ or V₀.

FIG. 1. illustrates details of DNN architecture to estimate intrachannel nonlinearity from the received inputs prepared as described earlier. The number of hidden layers and the number of neurons in each layer need be optimized to maximize the performance improvement. In FIG. 1, 2 hidden layers with 2 and 10 neurons are shown as a typical example. It can be observed the major complexity is proportional to the number of input nodes.

The Node 1 is used as an example to show the simplification of the computation in the NN-NLC.

f₁=HₙHₘ₊ₘ*Hₘ×W₁+VₙVₘ₊ₙ*Hₘ×W₁b₁ (1)

After training is complete, weight W₁ and bias b₁ are fixed. In addition, the input triplets are only selected from limited alphabets in the selected modulation formats (QPSK, 16 QAM and so on). For modulation formats with symmetry, possible values of the corresponding triplets becomes much less than M³ distinct outputs, which significantly reduce the required LUT size.

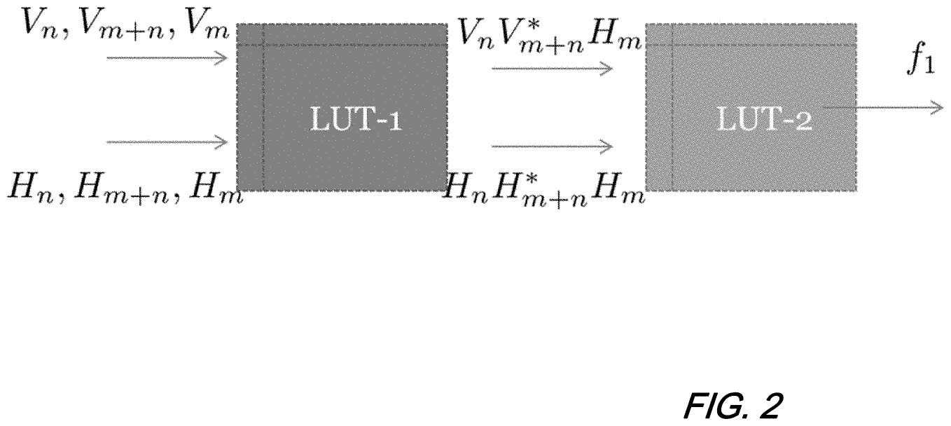

Note that the first two terms on the right of the equation (1) are computed by using the same LUT. As a result, the all the multiplications in the neurons are able to be replaced by the same LUT. FIG. 2 is a schematic flow diagram showing illustrative two lookup tables (LUTs) for implementing NN-NLC according to aspects of the present disclosure. The flow diagram shown illustrates a first LUT (LUT-1) that used for computing triplets involving the six symbols and a second LUT (LUT-2) designed to implement the right-hand side of Eq. (1) after the weight and bias of the Node 1 are fixed in the test stage. All the values of weight W₁ and bias b₁ is known in the test stage, so that the multiplied values of triplets and weights can be pre-calculated.

By storing the multiplied values into LUT-2, as can be observed, all the multiplication has been successfully removed while only keeping the summation in each node. Also, by considering the effective bit resolution for ASIC implementation, the possible values of the weights and the biases are limited by the bit resolution. Typical bit resolution of the ASIC for high-speed optical transceivers ranges from 6 to 8 bits, that is from 64 to 256, which contributes to reduce the memory size of LUT-2.

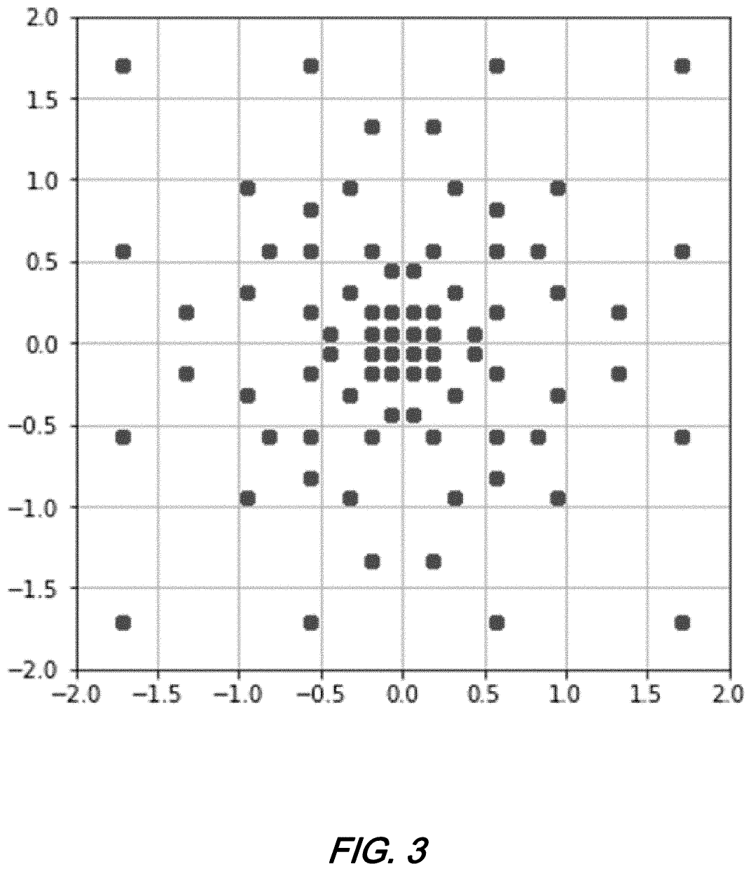

FIG. 3 shows a constellation plot illustrating possible values of corresponding triplets from 16 QAM according to aspects of the present disclosure. With reference to that figure, we note that given M=16 for 16 QAM, there are M³ (16³=4096) possible outputs. Due to symmetry of the constellations, the possible vales of the corresponding triplets are significantly reduced to 80 as depicted in that FIG. 3. Therefore, the size of the LUT-1 is estimated as 4096×80 at most, which is implementable scale of current generation of ASICs.

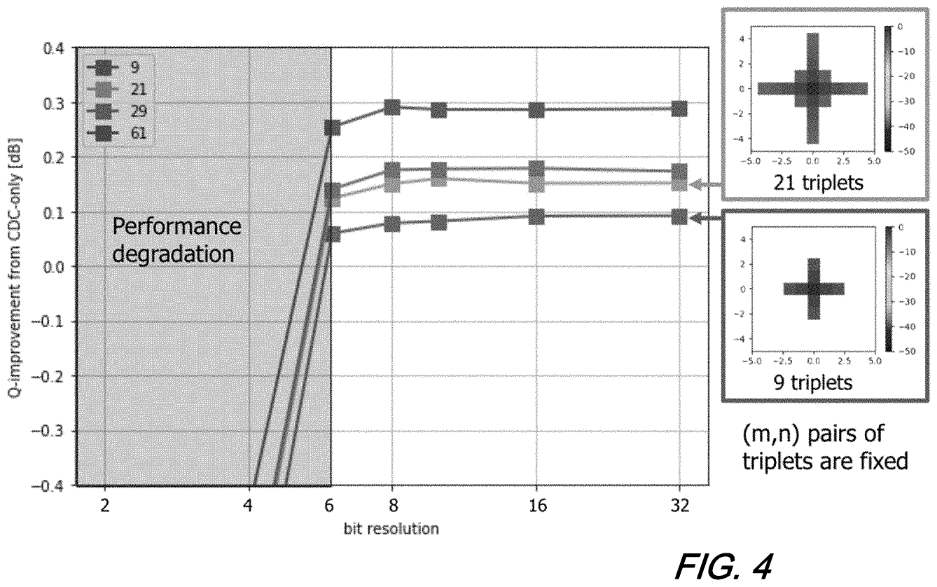

The bit-resolution of NN-NLC determines the quality improvement of nonlinearity compensation. For 16 QAM signals, transmission simulation shows that 6 bit resolution is enough within 0.1 dB degradation as is depicted in FIG. 4, which shows a plot illustrating Q-improvement dependency on bit resolution according to aspects of the present disclosure.

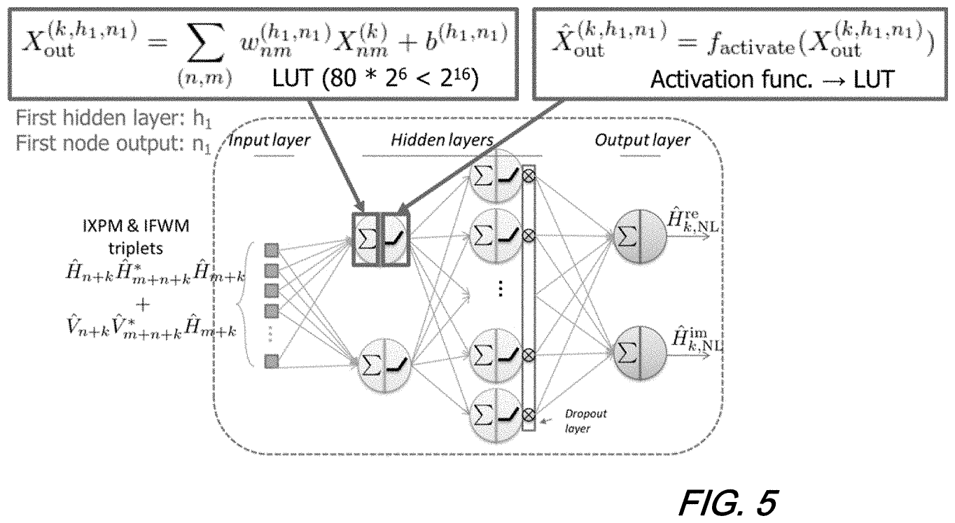

We note that the bit-resolution of LUT-2 is fine with 6 bit-resolution. Also, the activation function to each hidden layer is possible to be stored using LUT with a finite bit-resolution. In the case of 6 bit-resolution, the activation function is quantized by 6 bits, that is, the LUT corresponding to the activation function only has 2⁶=64 elements. FIG. 5 shows a schematic diagram illustrating LUT-based NN-NLC according to aspects of the present disclosure.

At this point, while we have presented this disclosure using some specific examples, those skilled in the art will recognize that our teachings are not so limited. Accordingly, this disclosure should only be limited by the scope of the claims attached hereto.

1. An optical transmission system comprising:
a deep neural network (DNN) that provides fiber nonlinear compensation, the DNN including an input layer, a plurality of hidden layers, and an output layer, said DNN CHARACTERIZED IN THAT:
two lookup tables (LUTs) are employed to provide all multiplication operations performed by the DNN.

2. The system of claim 1, FURTHER CHARACTERIZED IN THAT:
the two LUTs are shared by a plurality of input nodes in the input layer.

3. The system of claim 2, FURTHER CHARACTERIZED IN THAT:
The DNN exhibits a feed-forward architecture.
